(19) United States
(12) Patent Application Publication
(10) Pub. No.: US 2002/0009404 A1
(43) Pub. Date: Jan. 24, 2002

(54) Molecular sieve adsorbent-catalyst for sulfur compound contaminated gas and liquid streams and process for its use

(75) Inventors: Albert M. Tsybulevskiy, Louisville, KY (US); Edward J. Rode, Louisville, KY (US)

Correspondence Address: Scott R. Cox, 400 West Market St., Suite 2200, Louisville, KY, 40202, US

(73) Assignee: Zeochem LLC, Louisville, KY

(21) Appl. No.: 09/907,975

(22) Filed: Jul. 18, 2001

Related U.S. Application Data
(62) Division of application No. 09/316,842, filed on May 21, 1999.

(51) Int. Cl. C01B 7/00; B01J 8/00

(52) U.S. Cl. 423/244.04; 423/244.09; 423/244.11

(57) ABSTRACT

An adsorbent-catalyst for removal of sulphur compounds from sulfur compound contaminated gas and liquid feed streams, wherein the adsorbent-catalyst is a synthetic X or Y faujasite with a silica to alumina ratio from 1.8:1 to about 5:1 and wherein 40 to 90% of the cations of the faujasite include transition metals of Groups IB, IIB and VIIB with the balance of the cations being alkali or alkaline earth metals.

### BACKGROUND OF INVENTION

1. Field of Invention

The present invention relates to a novel adsorbent-catalyst for removal of sulfur compounds, including mercaptans, sulfides, disulfides, sulfoxides, thiophenes, and thiophanes from liquid and gas feed streams, and more particularly, an adsorbent-catalyst for purification of hydrocarbons, petroleum distillates, natural gas and natural gas liquids, associated and refinery gases, air, hydrogen, and carbon dioxide streams. The invention also relates to a process for gas and liquid purification using this adsorbent-catalyst.

2. Background Art

Most organo-sulfur compounds possess a strong and troublesome odor. Thus, gases and liquids, which contain even a very small amount of these compounds, have a bad smell. Owing to this problem, the technology of removing these substances is conventionally termed as “sweetening” or deodorization. These sulfur-contaminated compounds are also corrosive, causing damage to technological equipment and transportation systems. Further, practically all sulfur-contaminated compounds are irreversible poisons for many catalysts used in chemical processes. In particular, the Group VIII metal catalysts show an exceptional sensitivity to sulfur poisoning. Therefore, such commercially important processes as natural gas steam reforming, individual hydrocarbons and petroleum distillate isomerization, platforming, hydrogenation, etc. require practically complete removal of the many sulfur compounds from the process feed before catalysis.

Several processes have been employed for gas and liquid “sweetening”. Adsorption of sulfur-contaminated compounds is the most common method for removal of these sulfur compounds because of the high performance and relatively low capital and operational costs. Numerous processes and adsorbents have been developed for the removal of organic sulfur compounds and hydrogen sulfide, carbon oxysulfide and carbon disulfide, from gases and liquids.

Sulfur adsorbents can be classified in two categories: chemisorbents, i.e., solid substances that chemically bind sulfur-contaminated compounds to the chemisorbent, and physisorbents, i.e., solid substances which physically adsorb the sulfur compounds.

Typically, chemisorbents for sulfur compounds include transition metals or metal oxides placed on an inorganic support. For example, U.S. Pat. Nos. 4,163,706 and 4,204,947 disclose adsorbents for the removal of thiols (mercaptans) from hydrocarbon oils, which comprise a composite compound having a copper component and an inorganic porous carrier. U.S. Pat. Nos. 4,225,417 and 5,106,484 disclose adsorbents for catalytic reforming catalyst protection, which comprise a manganese oxide-containing composition as the main chemisorption agent. U.S. Pat. No. 4,613,724 discloses the use of zinc oxide/alumina or zinc oxide/aluminosilicate compositions for removing carbonyl sulfide from a liquid olefinic feedstock. U.S. Pat. No. 5,360,468 describes an adsorbent for hydrogen sulfide removal from natural gas, which comprises zinc oxide on an alumina phosphate support. U.S. Pat. No. 5,710,089 discloses a sorbent composition that consists of zinc oxide, silica, and a colloidal metal oxide component, selected from the group of alumina, silica, titania, zirconia, copper oxide, iron oxide, molybdenum oxide, etc. For lowering sulfur levels in gas streams to ultra low levels and for protection of a catalytic reforming catalyst, U.S. Pat. No. 5,322,615 discloses the use of an adsorbent which consists of nickel metal on an inorganic oxide support.

All such chemisorbents provide high sulfur recovery, sometimes down to the level of tens or hundreds of parts per billion (ppb). However, such adsorption must occur at elevated temperatures for adequate performance. The typical temperature range for chemisorbent operation is from 70° C. up to 500° C. and higher. In the process of the chemisorbent, sulfur compounds are converted to metal sulfides on the surface of these chemisorbents, making the chemisorbent nonregenerable or, at best, very hard to regenerate. As a result, most sulfur chemisorbents are in operation for only 1-2 years and then must be replaced. Another disadvantage of the chemisorbents is a limitation on their use where the sulfur-contaminated compounds are present at higher levels in the feed stream. Gas and liquid purification with chemisorbents is only practical when the level of sulfur impurities in the feed stream does not exceed 20-30 parts per million (ppm).

The most widely used physical adsorbents for these sulfur compounds are synthetic zeolites or molecular sieves. For example, U.S. Pat. Nos. 2,882,243 and 2,882,244 disclose an enhanced adsorption capacity of molecular sieves NaA, CaA and MgA for hydrogen sulfide at ambient temperatures. U.S. Pat. No. 3,760,029 discloses the use of synthetic faujasites as an adsorbent for dimethyl disulfide removal from normal paraffins. U.S. Pat. Nos. 3,816,975, 4,540,842 and 4,795,545 disclose the use of standard molecular sieve 13X as a sulfur adsorbent for the purification of liquid hydrocarbon feedstocks. For removal of carbonyl sulfide, mercaptans, and other sulfur compounds from liquid normal paraffins, U.S. Pat. No. 4,098,684 discloses the use of combined beds of molecular sieves 13X and 4A. European Patent No. 781,832 discloses zeolites of types A, X, Y, and MFI as adsorbents for hydrogen sulfide and tetrahydrothiophene in natural gas feed streams. Japan Patent No. 97,151,139 discloses a NaY faujasite-type molecular sieve for benzothiophene separation from naphtalene.

To facilitate regeneration of the molecular sieves by removing the sulfur compounds adsorbed, the use of cation exchanged forms of zeolite types A, X, Y have been proposed due to their catalytic activity in the reduction or oxidation reaction of sulfur compounds at the regeneration stage. For instance, U.S. Pat. No. 4,358,297 discloses the use of a Cd-exchanged form of molecular sieve A for sulfur removal from liquid hydrocarbon streams. The '297 patent further discloses regeneration of the adsorbent using hydrogen or a hydrogen-contaminated stream at elevated temperatures, 200-650° C., resulting in conversion of the organo-sulfur compounds to hydrogen sulfide. U.S. Pat. No. 5,843,300 discloses a regenerable adsorbent for gasoline purification that comprised a potassium-exchanged form of a standard zeolite X impregnated with up to 1% by weight zero valent platinum or palladium. This noble metal component provides hydrogenation of the adsorbed organic sulfur compounds in the course of the adsorbent regeneration. However, the introduction of noble metals into the adsorbent composition substantially increases the cost of the adsorbent.

Another example of an adsorbent is disclosed by U.S. Pat. No. 3,864,452. This patent discloses ion exchanged forms of zeolites A, X, and Y as adsorbents for natural gas desulfurization, which at the regeneration stage, provides conversion of sulfur-contaminated compounds to elemental sulfur using oxygen-containing gas at a temperature of, at least, 440° C.

All of these molecular sieve physical adsorbents can work at ambient temperature and have a substantial capacity for removal of sulfur compounds at relatively high concentrations. The main disadvantage of these adsorbents is their inability to provide significant levels of sulfur removal (down to levels of less than 1 ppm) that some applications like deodorization and catalyst protection require. For example, according to the U.S. Pat. No. 4,098,684, molecular sieve 13X has a 6.5% wt. adsorption capacity for ethyl mercaptan (800 ppm in pentane). However, it can provide a mercaptan breakthrough concentration only to the level of about 20 ppm.

Because both chemisorbents and physisorbents have significant and antipodal failings in commercial performance, combinations of conventional chemisorbents and physisorbents have been suggested to eliminate their individual deficiencies. U.S. Pat. Nos. 4,830,734 and 5,114,689 disclose the use of an integrated bed of molecular sieves 4A, 5A, and 13X physisorbents and chemisorbents, such as zinc oxide, iron oxide, etc. U.S. Pat. No. 4,673,557 discloses an intimate mixture of zinc oxide and a zeolite having an average pore size larger than 4 Å, i.e. molecular sieve 5A or 13X, for hydrogen sulfide removal from gases. Japan Patent No. 97,313,931 discloses an intimate blend of copper/manganese oxides and zeolites of mordenite and pentasil group.

All of these combinations provide an enhanced degree of sulfur recovery over a broad range of concentrations. However, due to completely different temperatures for the preferred uses and conditions of operation of the chemical and physical adsorption constituents, such integrated adsorbent beds or blended adsorbents demand complicated purification process flow sheet and result in an increase in operational costs.

Another alternative direction consists of introduction of transition, lanthanide or noble metal ions into a zeolite framework. For example, U.S. Pat. No. 5,057,473 discloses a desulfurization adsorbent, which comprises a mono-cation (copper) or bication (copper-lanthanum) exchanged form of a molecular sieve X. U.S. Pat. No. 5,146,039 discloses the use a zeolite containing copper, silver, zinc or mixtures thereof for low level recovery of sulfides and polysulfides from hydrocarbons. Both of these adsorbents employ chemisorption.

A CuLaX adsorbent, produced according to U.S. Pat. No. 5,057,473, provides diesel fuel desulfurization at 250-300° C. with sulfur recovery not exceeding 60%. Regeneration of the spent adsorbent is complicated and requires two stages: sulfidizing and oxidation.

ZnCuX and AgCuX adsorbents, produced according to the U.S. Pat. No. 5,146,039, provide practically complete removal of sulfides and disulfides (to the level of 5 ppb) at temperatures of 60-120° C. However, their adsorption capacity is very low. Hydrocarbon feeds with sulfur content levels higher than 20 ppm cannot be used with these adsorbents.

U.S. Pat. No. 4,188,285 discloses an adsorbent for thiophene removal from gasoline, which comprises a silver-exchanged form of an ultra stable-faujasite Y. This regenerable adsorbent adsorbs in a temperature range of 20-370° C. and provides a low level of residual sulfur in the product with substantial adsorption capacity. However, due to the relatively high content of silver, the price of the adsorbent may not allow any significant commercial application.

Japan Patent Nos. 97,75,721 and 98,327,473 disclose the use for gas purification of binderless molecular sieves A and X in bi- and trication exchanged forms of transition metals selected from Mn, Co, Cu, Fe, Ni, and Pt. This chemisorbent efficiently removes sulfur at ambient temperature, but possesses a low adsorption capacity. Thus, these references suggest the use of an adsorbent for removal of impurities at trace levels only. Also, the high cost of the adsorbent as a result of the utilization of noble metals limits the use of these adsorbent to such exotic applications as hydrogen purification for fuel cells.

Finally, U.S. Pat. No. 5,807,475 discloses an adsorbent for thiophene and mercaptan removal from gasoline, which constitutes nickel- or molybdenum-exchanged forms of zeolite X or Y, or a smectite layered clay. This adsorbent adsorbs in a temperature range of 10-100° C. However, according to the Example 7, its adsorption capacity for sulfur is not high and its sulfur recovery does not exceed 40-50%.

While many of these products have been useful for gas and liquid stream purification of sulfur-contaminated compounds, it is important to provide improved adsorbents which do not possess the disadvantages mentioned above.

Accordingly, it is an aspect of the invention to provide an adsorbent for sulfur-contaminated feed streams with enhanced adsorption capacity over an extended range of sulfur concentrations.

It is a further aspect of the invention to provide a low cost adsorbent for sulfur compounds.

It is a still further aspect of the invention to provide an adsorbent-catalyst having catalytic activity for conversion of sulfur contaminated compounds and enhanced adsorption capacity for higher molecular weight sulfur products after catalytic conversion over an extended range of sulfur concentrations.

It is a further aspect of the invention to provide a regenerable adsorbent-catalyst with the ability to adsorb very low quantities of sulfur-contaminated compounds over a broad temperature range.

It is a still further aspect of the invention to disclose an adsorbent-catalyst with capability to purify feed streams of practically all organo-sulfur compounds, including thiols (mercaptans), sulfides, disulfides, sulfoxides, thiophenes, thiophanes, etc. as well as hydrogen sulfide, carbon oxysulfide, and carbon disulfide, individually or in combination thereof.

It is a still further aspect of the invention to disclose a process for the removal of sulfur-containing compounds using an adsorbent-catalyst which produces gas and liquid feed streams containing less than one part per million, preferably less than 300 parts per billion, more preferably less than 50 parts per billion of the sulfur-containing compounds in the feed stream.

These and further aspects of the invention will be apparent from foregoing description of a preferred embodiment of the invention.

### SUMMARY OF INVENTION

The present invention is an adsorbent-catalyst for removing sulfur compounds from sulfur contaminated gas and liquid feed streams which exhibits enhanced adsorption capacity over a broad range of sulfur compound concentrations and temperatures. The adsorbent-catalyst constitutes synthetic zeolite X or Y faujasites, wherein the silica to alumina ratio is from about 1.8:1 to about 5:1, preferably from about 2.0:1 to about 2.2:1, and wherein exchangeable cations are introduced into the synthetic faujasite structure including transition metals selected from the group consisting of Group IB, IIB and VIIB of the Periodic Table, preferably metals selected from bivalent cations of copper, zinc, cadmium and manganese. Said transition metal cation content in the faujasite structure comprises from about 40 to about 90% (equiv.), preferably from about 50 to about 75% (equiv.), with the balance of the cations being alkali and/or alkaline-earth metals, preferably selected from the group of sodium, potassium, calcium and magnesium.

The present invention is also a process for purifying gas and liquid feed streams contaminated with organic sulfur compounds which comprises passing said gas and liquid feed streams over an adsorbent-catalyst at a temperature from about 10 to about 60° C. and regenerating said adsorbent-catalyst in a gas flow at a temperature from about 180 to about 300° C.

### BRIEF DESCRIPTION OF THE DRAWINGS

FIG. 1 shows a chromatogram of a sample of purified n-pentane using a conventional molecular sieve 13X for removal of ethyl mercaptan from the n-pentane stream. No new substances were detected in n-pentane solution after contact with the adsorbent.

FIG. 2 shows a similar chromatogram for n-pentane purification using a MnLSF adsorbent-catalyst according to the present invention (Example 7). Significant amounts of mono-, di-, and triethylsulfide were observed along with the initial ethyl mercaptan after a short time of interaction with the adsorbent-catalyst.

### DISCLOSURE OF THE INVENTION

Synthetic faujasites with silica/alumina ratio of 1.8:1-5.0:1 have previously been developed for the adsorption of sulfur-contaminated compounds from gas and liquid streams. In these conventional faujasites, the sodium cations present have been substituted for by other metal ions having larger size. However, such substitutions conventionally decrease the adsorption capacity of the faujasites for sulfur-containing organic compounds. For example, it is known that the potassium and calcium forms of a faujasite X type adsorbents are characterized by a substantially lower adsorption capacity for alkyl mercaptans and hydrogen sulfide than the sodium form of the same faujasite X.

It has been surprisingly discovered that substitution of sodium cations in a synthetic faujasite structure with transition metal (TRM) ions, preferably Zn, Mn, Cu, and Cd, results in a 1.5-3.0 times increase in the adsorption capacity of the synthetic faujasites for sulfur-containing compounds. It has also been surprisingly discovered that these transition metal forms of synthetic faujasites (TMF) display enhanced adsorption capacity even at low concentrations of the sulfur-containing compounds, i.e., below 1 ppm. This high capacity for removal of sulfur-containing compounds results in an enhanced level of sulfur purification for feed streams.

It has also been surprisingly discovered that these TMF adsorb organic sulfur compounds reversibly. In contrast to transition metal oxides, such as zinc oxide and manganese oxide, the respective Zn, Mn, Cu, or Cd faujasite X or Y zeolites adsorb significant quantities of sulfur compounds by means of physisorption. TMF can desorb these sulfur compounds by heating them to temperatures in the range of 180-300° C. Therefore, it has been discovered that TMF can serve as regenerable adsorbents with enhanced sulfur adsorption capacity.

Thus, a method for reversible and enhanced adsorption of sulfur contaminated compounds using transition metal forms of synthetic faujasites has been discovered. Although not wanting to be limited to a particular mechanism, it appears that these sulfur compounds undergo a catalytic conversion on the TMF resulting in the formation of substances having an increased molecular weight. For example, mercaptans are oxidized to sulfides and/or polysulfides. These higher molecular weight sulfur compounds are then adsorbed by these synthetic faujasites. The physical adsorption of these sulfur compounds on zeolites is increased, due to their higher molecular weight. Because the adsorption of the sulfur compounds on the synthetic faujasites of the present invention is a two-stage process, i.e., first catalytic conversion of sulfur contaminated compounds, followed by physical adsorption of the catalytically converted products, these synthetic faujasites which are the subject of the present invention are termed “adsorbent-catalyst.”

Sulfur in sulfide, and particularly in disulfide, trisulfide, and larger molecules, is significantly less reactive than in the SH-group of mercaptans. Therefore, these sulfides do not react with the TRM cations at temperatures below 300° C. Instead, they are adsorbed due to dispersion and polarization forces, and can be removed from the adsorbents by heat treating.

It has been discovered that an acceptable range of ion exchange of TRM ions in the faujasite structure is about 40-90% (equiv.). A surprisingly preferred range of substitution for TRM ions is between about 50-75%. The transformation of organic sulfur contaminants is less efficient where substitution levels are below about 40%. It has unexpectedly been discovered that TMF adsorption capacity for sulfides, polysulfides, and sulfoxides substantially decreases where the ion exchange level is higher than about 75% (equiv.). Therefore, transition metal forms of faujasites with ion exchange levels of from about 50% to about 75% possess a superior capacity for adsorbing sulfur-contaminated compounds and provide a significant level of adsorption of these compounds from liquid and gas streams.

The balance of the ions in the faujasite structure are preferably alkali and/or alkaline earth metals. These alkali or alkaline earth metals comprise about 10 to about 60% (equiv.) of total cations. In a preferred embodiment, when the TRM ions comprise about 50 to about 75%, the balance of the ions in the TMF comprise from about 25 to about 50% (equiv.) alkali and/or alkaline earth metals. Preferably, the alkali and/or alkaline earth metals are selected from sodium, potassium, calcium and magnesium.

Generally, TMF are formed by conventional ion exchange procedures utilizing aqueous solutions of metal salts, for instance, TRM-chlorides, nitrates, sulfates, acetates, etc. There are several methodologies that may be used to produce these TMF. An ion exchange of the sodium form of faujasite with TRM salt solution can be performed on a zeolite powder or in a granule. For example, a powder exchange can be accomplished on a belt filter or in a tank with one, two, or three stages of TRM-chloride solution treating. The concentration of the TRM-chloride may vary from about 0.05 to 3.0 N.

The TMF zeolite powder produced is then admixed with a binder to produce a final adsorbent-catalyst product. The binder can be chosen from conventional mineral or synthetic materials, such as clays (kaolinite, bentonite, montmorillonite, attapulgite, smectite, etc.), silica, alumina, alumina hydrate (pseudoboehmite), alumina trihydrate, alumosilicates, cements, etc. The mixture is then kneaded with 18-35% water to form a paste, which is then aggregated to form shaped articles of conventional shapes such as extrudates, beads, tablets, etc.

In an alternative method of production, granulated sodium forms of faujasite X and Y in the shape of extrudates, beads, tablets, etc. are ion exchanged in a column with a TRM salt solution.

In either process, it is important that the concentration of TRM salt solution be maintained, as discussed above, so that the equivalent ratio of TRM ions in solution to sodium in the zeolite is greater than 1.0, preferably greater than 1.25. The ion-exchanged product is then washed with deionized water to remove excess TRM ions, dried, and calcined at a temperature from about 250 to about 550° C.

Utilizing transition metal forms of faujasites produced by the above-described process creates products particularly useful for the purification of gas and liquid streams from sulfur compounds. The preferred types of gas streams, in which this type of adsorbent can be utilized, include natural, associated, and refinery gases, monomers, hydrogen and hydrogen-containing streams, nitrogen, carbon dioxide, and other such gas systems. The liquid streams, which can be favorably purified by the adsorbent-catalyst, according to the present invention, include individual hydrocarbons, liquid petroleum gas (LPG), natural gas liquid (NGL), light naphtha, gasoline, jet fuel, and other liquid systems such as mineral, vegetable and animal oils.

Another surprising aspect of this adsorbent-catalyst is its ability to be regenerated within reasonable process parameters. For example, the purification of a gas stream typically occurs in a fixed bed of the adsorbent-catalyst at temperatures from about 10 to about 60° C., pressures from atmospheric to about 120 bars and gas flow linear velocities through the adsorbent bed from about 0.03 to about 0.35 m/sec. The thermal regeneration of the adsorbent-catalyst when loaded with sulfur compounds is performed in a purified and dried gas flow at temperatures preferably from about 180 to about 250° C., which regeneration can occur shortly after sulfur compound breakthrough of the adsorbent bed.

It has also been established that the adsorbent-catalyst, according to the present invention, when employed in a conventional natural gas demercaptanization process, reduces the mercaptan concentration to a range of about 10-20 ppb, a level unavailable from typical physical adsorbents. Currently, ammonia, methanol, and carbamide plant, inlet natural gas steam reforming units, utilize zinc oxide, zinc-copper oxide, or zinc-manganese oxide-type chemisorbents to reach 100-300 ppb demercaptanization level.

In order to reduce consumption of these expensive chemisorbents, plants often employ a two-stage natural gas purification. First, physical adsorption occurs over standard molecular sieves SA or 13X producing mercaptan level in natural gas decrease from 15-20 ppm to 1-2 ppm. Then a second stage of purification utilizing Zno-type chemisorbent reduces the mercaptan content to a level of 100-300 ppb, which is required for nickel steam reforming catalyst protection. It has been discovered that the adsorbent-catalysts according to the present invention are highly efficient in mercaptan adsorption and at the same time provide a significant reduction in sulfur compound levels in gas streams in one step, without the use of high temperature. In addition, the adsorption of these sulfur compounds is reversible.

The process of liquid stream purification, for example, for n-butane, n-pentane or LPG (liquid petroleum gas) consists of contacting those liquids with the adsorbent-catalysts of the present invention under the following conditions: a LHSV (liquid volume/adsorbent volume/hour) in a range from 0.1 to 20 h⁻¹, temperatures in the range from 10 to about 40° C., and pressures in the range from about 3 to about 60 bars. The purification process can be conducted for as long as there are traces of undesired sulfur-contaminating compounds appearing in the liquid flow outlet of the adsorbent-catalyst bed. At that point, the adsorbent bed, which is then loaded with sulfur compounds, can be depressurized, purged from liquid with a gas flow and regenerated by thermal regeneration in a temperature range from about 180 to about 300° C. Natural gas, ethane, nitrogen, hydrogen, ammonia or evaporated hydrocarbons may be used as the regeneration agent.

It has been surprisingly established that Zn-, Mn-, and Cu-exchanged forms of the faujasites LSF and X with an ion exchange degree greater than about 40% (equiv.), when employed in an n-paraffin purification process at ambient temperatures, reduces the sulfur-contaminated compounds content in the liquid stream to a range of about 100-300 ppb, which is 8-10 times lower than can be produced using a conventional physisorbent, such as 13X. Conventional adsorbents, such as the sodium form of the faujasite X, or 13X are used extensively for the purification of n-butane and n-pentane isomerization and dehydrogenation processes for the respective catalysts protection and usually provide purification levels down to only about 1-2 ppm. The adsorbent-catalysts, according to the present invention, can provide improved and more reliable protection of the catalysts in large-scale commercial processes, such as Butamer and Hysomer.

In order to illustrate the present invention and the advantages thereof, the following examples are provided. It is understood that these examples are illustrative and do not provide any limitation on the invention.

### EXAMPLES 1 TO 3

### (According to the Invention)

100 g of a beaded sodium-potassium LSF molecular sieve with a silica/alumina ratio of 2.02 and particle size of 8×12 mesh were treated with 1L of a 1N water solution of zinc chloride (Example 1) and manganese chloride (Example 2). In Example 3, 100 g of standard 13X beads with a silica/alumina ratio of 2.35 were treated with 1 L of a 1N solution of cadmium nitrate. To keep the pH of the solution at a level greater than 6.5 and to avoid precipitation of the transition metal hydroxides, 50 ml of a standard buffer solution, 0.05M potassium monobasic phosphate solution, was added. The mixtures were maintained at ambient temperature for 4 hours. The products were then washed with deionized water to remove excess chloride or nitrate ions, dried at 110° C. for 3 hours, and calcined first at 250° C. for 2 hours and then at 350° C. for 1 hour. The analyses of the final products, which were conducted by Inductively Coupled Plasma Atomic Emission Spectroscopy, showed the following cation compositions of the resulting products:

Example 1: Zn—62%; Na—32%; K—5; Ca—1 % (equiv.);

Example 2: Mn—54%; Na—39%; K—6; Ca—1 % (equiv.);

Example 3: Cd—53%; Na—46%; K—1; Ca—0 % (equiv.).

### EXAMPLES 4 AND 5

### (According to the Invention)

200g of a NaKLSF molecular sieve beads with a silica/alumina ratio 2.02 were treated at room temperature with 2 L of a 1N solution of calcium chloride for over 3 hours. 100 g of the resulting material were treated with 1 L of a 1N solution of zinc chloride (Example 4) as described in Example 1. Another 100 g of Ca-exchanged LSF material were treated with 1 L of 1N solution of copper chloride. The operating procedures of Examples 1-3 for bead washing, drying, and calcining were repeated. The cation composition of the adsorbent samples produced was:

Example 4: Zn—66%; Ca—28%; Na—5; K—1 % (equiv.);

Example 5: Cu—53%; Ca—31%; Na—19; K—7 % (equiv.).

### EXAMPLE 6

### (Adsorption Equilibrium Test)

The samples of Examples 1 through 5 were tested for butyl and ethyl mercaptans adsorption equilibrium for toluene and n-pentane solutions respectively. To compare the products of the invention with conventional products, conventional adsorbents, such as molecular sieves 5A of Zeochem, manufactured under registered trademark Z5-02; 13X adsorbents (U.S. Pat. No. 4,098,684) of UOP, manufactured as 13X HP product; and NaLSF adsorbents of Zeochem, manufactured as Z10-10 product were utilized. Mercaptan adsorption of the respective adsorbents was measured employing the following methodology:

0.1-1.0 g of the adsorbent was placed in a glass container with 100-500 ml of the stock solution. The stock solution of mercaptans in hydrocarbons with concentration of 50 ppm were prepared employing Hamilton micro syringes and a measuring flask dilution method. The mixture was maintained at ambient temperature for 2-3 days with intermittent shaking for 3-4 hours every day until the concentration of the contaminant reached a constant value. The solution samples were removed through a septum of the container every day just after the shaking of the adsorbent-catalyst solution mixtures. Analysis of the stock and research solutions were carried out by means of Varian 3800 gas chromatograph with a pulse flame photometric detector (PFPD) and 6.0 m megabore column with DB-1 stationary liquid phase. The results for adsorption capacity of the samples are shown in Table 1.

TABLE 1

Equilibrium Adsorption Capacity, % w.

| | n-Butylmercaptan | Ethyl Mercaptan |
|---|---|---|
| | from Toluene | from n-Pentane |
| Adsorbent | 50 ppm | 50 ppm |
| Example 1 | 0.355 | 0.95 |
| Example 2 | 0.247 | 1.05 |
| Example 3 | 0.17 | 0.88 |
| Example 4 | 0.30 | 0.75 |
| Example 5 | 0.610 | 0.72 |
| 5A | 0.06 | 0.26 |
| 13X | 0.15 | 0.58 |
| NaLSF | 0.18 | 0.27 |

The adsorbent-catalyst, according to the present invention, Zn-, Mn-, Cu-, and Cd-exchanged forms of faujasite LSF and X, demonstrated a significantly higher adsorption capacity for alkyl mercaptans than that of the conventional adsorbents, such as zeolite 5A, 13X, and NaLSF.

### EXAMPLE 7

### (Chromatographic Analysis of the Purified Hydrocarbons)

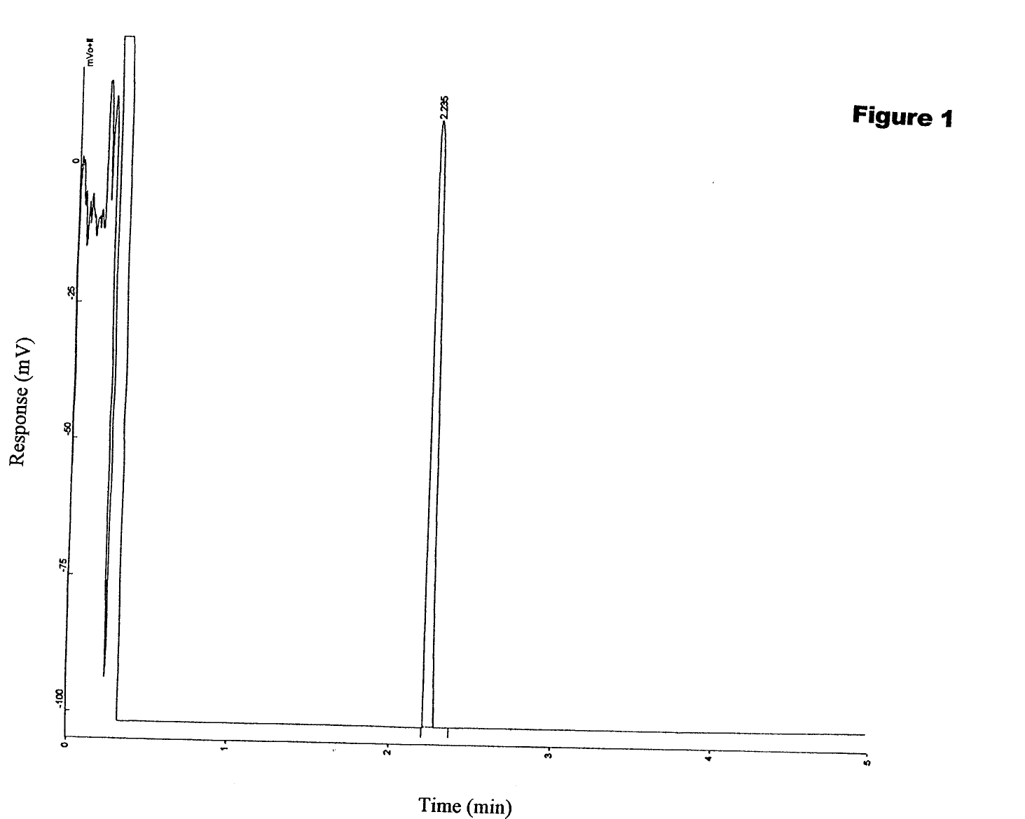

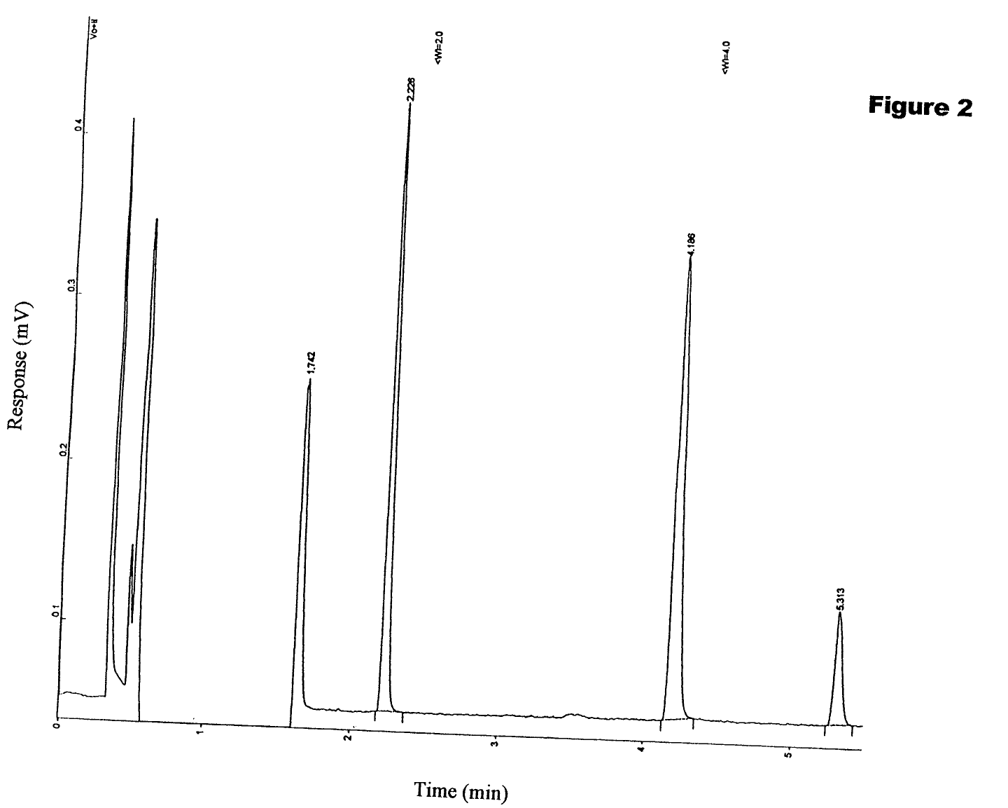

The adsorbent-catalyst of Example 2, MnLSF, along with a standard molecular sieve 13X, were tested for adsorption capacity for ethyl mercaptan from n-pentane, as described in Example 6. Solution samples were taken every 6 hours for analysis. 6 hours of exposure to the adsorbent-catalyst in solution was adequate for partial conversion of ethyl mercaptan to sulfides while it was insufficient for complete adsorption of the reaction products. The analysis of these results is shown in the chromatograms of FIGS. 1 and 2. As is apparent from these chromatograms, no new substances were detected using a conventional 13X adsorbent besides the original reactant ethyl mercaptan peak with the retention time of 2.23 min. (FIG. 1). Meanwhile, the chromatogram of FIG. 2 for the adsorbent-catalyst, according to the invention, MnLSF, demonstrated three new peaks, with the retention times of 1.74; 4.19; and 5.13 min. Specific experiments with pure substances showed that these new peaks on the chromatogram of FIG. 2 disclose the presence of ethyl sulfide (retention time 1.74 min.), diethyl disulfide (4.19 min.), and ethyl trisulfide (5.13 min.).

Therefore, it has been surprisingly found that adsorbent-catalysts, according to the present invention, convert alkyl mercaptans to sulfides and polysulfides at ambient temperatures. This unusual activity allows them to adsorb sulfur-contaminated compounds in a substantially greater amount than conventional zeolite adsorbent 13X (See also Example 11).

### EXAMPLE 8

### (Test of the Adsorbent-Catalysts' Ability to Regenerate)

The adsorbent-catalysts of Examples 1 and 2 were tested to evaluate their ability to desorb adsorbed sulfur-contaminated compounds. After ethyl mercaptan adsorption measuring, as described in Example 6, the samples were dried at 110° C. for 1 hour and then heated at 250° C. for 4 hours. The operating procedure of Example 6 for equilibrium adsorption measuring was repeated. Adsorption-regeneration cycles were carried out 4 times. The results are reported in Table 2.

Table 2 demonstrates regenerability of the adsorbent-catalysts, according to the present invention. Adsorption of sulfur-contaminated compounds on ZnLSF and MnLSF was reversible and the adsorption values showed good reproducibility from cycle to cycle. Therefore, the data of Table 2 confirm that the adsorbent-catalysts, according to the invention, provide reliable and durable purification.

TABLE 2

Adsorption Capacity, % w.

Cycle Number

| Example | Fresh | 1 | 2 | 3 | 4 |
|---|---|---|---|---|---|
| 1 | 0.95 | 0.87 | 0.93 | 0.89 | 0.87 |
| 2 | 1.05 | 1.09 | 1.00 | 1.04 | 1.01 |

EXAMPLE 9

### (According to the Invention)

50g of synthetic faujasite NaY beads having silica/alumina ratio of 4.6, were treated at room temperature with 0.5 L of a 1N solution of zinc chloride for 3 hours. The operating procedure of Examples 1-3 for bead washing, drying and calcining was then repeated.

The final product cation composition is:

Zn—73%, Na—27% (equiv.)

### EXAMPLE 10

### (High Temperature Adsorption Test)

The adsorbent-catalysts of Examples 1, 5 and 9, compared to standard molecular sieves 13X and NaLSF, were tested for adsorption of butyl mercaptan from toluene following the procedures that were described in Example 6. The measurements were carried out at two temperatures, 25° C. and 75° C. The results are presented in Table 3.

TABLE 3

Adsorption Capacity, % w.

| Adsorbent | 25° C. | 75° C. |
|---|---|---|
| Example 1 | 0.355 | 0.195 |
| Example 5 | 0.61 | 0.66 |
| Example 9 | 0.235 | 0.17 |
| 13X | 0.15 | 0.01 |
| NaLSF | 0.18 | 0.04 |

The adsorbent-catalysts, according to the present invention, in contrast to the conventional molecular sieve adsorbent-catalysts, retained their ability for adsorbing mercaptans and even increased adsorption capacity at high temperature. This shows that the adsorbent-catalyst products of the invention can be employed as universal adsorbent-catalysts over a broad temperature range including the range currently used exclusively for chemisorbents.

### EXAMPLE 11

### (Sulfides, Sulfoxides and Thiophene Adsorption Test)

The adsorbent-catalysts of Examples 1, 2, 5 and 9 were tested in diethyl sulfide (DES), dimethyl disulfide (DMDS), diethyl disulfide (DEDS), dimethyl sulfoxide (DMSO), and 2-methylthiophene (2-MT) adsorption equilibrium at ambient temperature following the procedure of Example 6. In the process, the initial concentrations of sulfides in n-pentane solution were: DES—50 ppm, DMDS—100 ppm, DEDS—110 ppm, DMSO—50 ppm, 2-MT—20 ppm. Standard molecular sieves 13X (U.S. Pat. No. 4,098,684)—13X HP of UOP manufacturing; 5A (U.S. Pat. No. 4,830,734)—Z5-02 of Zeochem manufacturing; CaX of W.R. Grace manufacturing; NaY of Engelhard manufacturing; and NaLSF of Zeochem manufacturing were utilized as comparisons. The results are reported in Table 4.

TABLE 4

| | Equilibrium Adsorption Capacity, % w | | | | |
|---|---|---|---|---|---|
| | DES | DMDS | DEDS | DMSO | 2-MT |
| Adsorbent | 50 ppm | 100 ppm | 110 ppm | 50 ppm | 20 ppm |
| Example 1 | 1.12 | 2.19 | 4.92 | 1.76 | 0.18 |
| Example 2 | 1.05 | 2.28 | 3.70 | 1.84 | 0.21 |
| Example 5 | 1.28 | 2.48 | 3.72 | 1.93 | 0.36 |
| Example 9 | N/A | 2.03 | 3.28 | N/A | N/A |
| 5A | 0.28 | 1.40 | N/A | N/A | N/A |
| 13X | 0.56 | 1.67 | 3.15 | 1.05 | 0.025 |
| CaX | 0.73 | 1.90 | N/A | N/A | N/A |
| NaLSF | 0.45 | 1.22 | 1.05 | 0.62 | 0.016 |
| NaY | N/A | 1.20 | N/A | 0.77 | 0.029 |

As in Example 11, the adsorbent-catalysts, according to the present invention, in comparison to the prior art adsorbents, displayed superior adsorption capacity for sulfides, disulfides, sulfoxides and thiophens. Comparison of the data of Tables 1 and 4 showed that, in contrast to conventional molecular sieves, adsorbent-catalysts, according to the present invention, possessed much higher adsorption capability for sulfur-contaminated compounds.

As in Example 7, mercaptans, in contact with the adsorbent-catalysts, according to the present invention, were converted to sulfides and polysulfides. Due to this catalytic activity and enhanced adsorption capacity for sulfides, the adsorbent-catalysts, according to the present invention, exhibited an outstanding ability for sulfur-containing substance sorbing.

### EXAMPLES 12 TO 15

### (Comparative)

The operating procedures of Example 1 for ZnLSF adsorbent-catalyst preparation were repeated except the concentration of zinc chloride solution was varied from 0.8 N to 2.2 N. Ion exchange of the original NaKLSF molecular sieve with zinc chloride solutions of various concentrations was used to obtain the following ion exchange degrees:

| | ZnCl₂ | Ion Exchange Degree, |
|---|---|---|
| Example | concentration, N | % (equiv.) |
| 12 | 0.6 | 43 |
| 13 | 0.8 | 51 |
| 14 | 1.5 | 74 |
| 15 | 2.2 | 81 |

### EXAMPLE 16

### (Mercaptans, Sulfides, and Sulfoxides Adsorption Test)

Adsorbent-catalysts of Example 12 to 15 were tested for ethyl mercaptan, dimethyl disulfide, and dimethyl sulfoxide adsorption at ambient temperature following the methodology of Example 6. The results for adsorption capacity determination are compared in Table 5 with the data for the adsorbents of Example 1.

TABLE 5

| | Ion Exchange | Adsorption Capacity, % w. | | |
|---|---|---|---|---|
| Example | Degree, % (equiv.) | EM | DMDS | DMSO |
| 1 | 62 | 0.95 | 2.19 | 1.76 |
| 12 | 43 | 0.68 | 1.92 | 1.12 |
| 13 | 51 | 0.88 | 2.04 | 1.55 |
| 14 | 74 | 1.07 | 2.30 | 1.90 |
| 15 | 81 | 0.73 | 1.66 | 1.45 |

The transition metal ion-exchanged faujasites with ion exchange levels between 50 and 75% (equiv.) of the adsorbent-catalyst of the present invention showed higher adsorption capacity for all sulfur contaminated compounds. Below 50% and above 75% of ion exchange, the adsorption capacity for mercaptans, sulfides and sulfoxides decreased.

### EXAMPLE 17

### (Toluene Purification Dynamic Test)

The adsorbent-catalysts of Examples 1 and 2, along with the standard adsorbent 13X, were tested for dynamic adsorption in toluene purification employing a tube adsorber. The adsorbent bed volume was 25 cm³, temperature −25° C. The samples were preliminarily treated at 110° C. for 1 hour and at 250° C. for 3 hours. Sulfur impurities in toluene flow had the following quantitative composition:

Ethyl sulfide—20 ppm;

Ethyl mercaptan—50 ppm;

Dimethyl disulfide—30 ppm.

Toluene was fed through the adsorption unit at a flow rate of 500 ml/hour. Purified hydrocarbon samples were taken every 15-min with the following analysis by means of a chromatograph, as described in Example 6. A breakthrough concentration and time before sulfur compound breakthrough was determined for each sample tested. The adsorption capacity of the samples before total sulfur breakthrough is disclosed in Table 6.

TABLE 6

| | Breakthrough Concentration, | Dynamic Capacity, |
|---|---|---|
| Adsorbent | ppb | % w. |
| Example 1 | 240 | 0.56 |
| Example 2 | 98 | 0.54 |
| 13X | 1250 | 0.31 |

The adsorbent-catalysts, according to the present invention, in comparison to the conventional adsorbents, demonstrated significantly better hydrocarbon purification. They provided significantly enhanced sulfur compound recovery and a higher adsorption capacity.

### EXAMPLE 18

### (Natural Gas Demercaptanization Test)

The adsorbent-catalysts of Examples 1, 2, and 5, along with a standard adsorbent 13X, were tested for natural gas purification from ethyl mercaptan employing a tube adsorber with an adsorbent bed volume of 180 cm³. The adsorber was furnished with a thermostatic jacket that permitted test runs at 25 and 75° C. Natural gas, containing 20 ppm of ethyl mercaptan, was fed through the absorber at a linear velocity of 0.1 m/sec. At the absorber outlet, gas went in a bubbler with toluene cooled to −21° C. Toluene samples were removed by means of a microsyringe, through a septum in the bubbler over a time interval of 10 min. This allowed an evaluation of mercaptan breakthrough concentration, time before breakthrough, and dynamic adsorption capacity. The results are presented in Table 7.

TABLE 7

| | |
|---|---|
| Breakthrough | Adsorption |
| Concentration, ppb | Capacity, % w. |

| Adsorbent | 25° C. | 75° C. | 25° C. | 75° C. |
|---|---|---|---|---|
| 13X | 880 | 2000 | 0.095 | 0.000 |
| Example 1 | 30 | 15 | 0.184 | 0.006 |
| Example 2 | 30 | 28 | 0.133 | 0.106 |
| Example 5 | 18 | 10 | 0.163 | 0.171 |

As in Example 18, the adsorbent-catalysts, according to the present invention, demonstrated a superior performance in gas stream purification. They produced sulfur recovery levels of 10-30 ppb that have never been reachable using conventional physical adsorbents. In the process of natural gas demercaptanization at low temperature, adsorbent-catalysts, according to the present invention, provided enhanced adsorption capacity, almost twice as effective as a conventional 13X molecular sieve adsorbent.

As the results of Table 7 show, the adsorbent-catalysts, according to the present invention, also acted like chemisorbents, at elevated temperatures. In contrast to prior art adsorbents, which gave immediate ethyl mercaptan breakthrough at 75° C., transition metal ion-exchanged faujasites showed deeper levels of sulfur recovery at higher temperature. At the same time, MnLSF (Example 2) and CuCaLSF (Example 5) did not decrease their dynamic capacity for ethyl mercaptan with the temperature increase.

Therefore, the adsorbent-catalysts, according to the present invention can be effectively utilized as adsorbents for first stage natural gas demercaptanization process instead of molecular sieves 13X, 5A, or 4A and as second stage adsorbents instead of chemisorbents, such as zinc oxide, manganese oxide, copper oxides, or blends of them. They can also serve as universal adsorbents providing deep gas purification in one step. This provides an opportunity for a substantial decrease in capital investments and operational costs in existing or new gas purification units.

Accordingly, the invention provides highly effective, reliable and cheap adsorbent-catalysts for sulfur contaminated compounds that can be used for gas and liquid stream purification processes with enhanced commercial performance. The adsorbent-catalysts can be used in new or existing plants. Furthermore, the insertion of transition metal cations into faujasite structure produces an adsorbent-catalyst, which possesses a number of advantages over prior art adsorbents:

(1) practically complete removal of sulfur-contaminated compounds from gas and liquid streams, down to a level of 10-200 ppb;

(2) adsorption of significant quantities of sulfur-contaminated compounds even at very low concentrations in the feed stream (less than 20ppm);

(3) virtually complete desorption of sulfur compounds with full reproducibility of original adsorption capabilities after thermal regeneration resulting in reduced operational costs in gas and liquid purification processes;

(4) a considerable adsorption capacity of a significant number of different organic sulfur compounds including mercaptans, sulfides, polysulfides, sulfoxides, thiophenes, etc. that eliminate the necessity for combined bed purification;

(5) substantial adsorption and deep level of sulfur recovery over a broad range of temperatures;

(6) substitution by adsorbent-catalysts of the present invention for physical adsorbents as well as chemisorbents, providing practically complete purification of gas and liquid streams in one step;

(7) reduced cost of adsorbents due to non-use of noble and rare-earth metals, and other high-price materials.

(8) highly efficient gas and liquid purification processes, resulting in a very low content of organic sulfur compounds in the purified stream, while at the same time not necessitating significant additional capital and operational costs to realize this adsorption capacity.

The adsorbent-catalyst can be used in powder form or can be formed as spheres, beads, cylinders, extrudates, pellets, granules, rings, multileaves, honeycomb or in monolith structures.

While the invention has been described in terms of various preferred embodiments, these should not be construed as limitations on the scope of the invention. Many other variations, modifications, substitutions and changes may be made without departing from the spirit thereof.

We claim:

1. An adsorbent-catalyst for first catalyzing sulfur compounds conversion to higher molecular weight sulfur products and then adsorbing the resulting sulfur products for removal from gas and liquid feed streams comprising a synthetic X or Y faujasite containing silica and alumina, wherein the silica to alumina molar ratio of the synthetic faujasite is from about 1.8:1 to about 5:1, and wherein cations of the synthetic faujasite comprise from about 40 to about 90 percent transition metals selected from the group consisting of Group IB, IIB and VIIB metals.

2. The adsorbent-catalyst of claim 1 wherein the cations of the synthetic faujasite further comprise from about 10 to about 60 percent alkali or alkaline earth metals and combinations thereof.

3. The adsorbent-catalyst of claim 1 wherein the cations of the synthetic faujasite comprise from about 50 to about 75 percent transition metals.

4. The adsorbent-catalyst of claim 3 wherein the cations of the synthetic faujasite further comprise from about 25 to about 50 percent alkali or alkaline earth metals or combinations thereof.

5. The adsorbent-catalyst of claim 1 wherein the silica to alumina molar ratio is from about 2.0 to about 2.2.

6. The adsorbent-catalyst of claim 1 wherein the transition metals are selected from the group consisting of copper, zinc, cadmium and manganese.

7. The adsorbent-catalyst of claim 3 wherein the transition metals are selected from the group consisting of copper, zinc, cadmium and manganese.

8. The adsorbent-catalyst of claim 2 wherein the alkali and alkaline earth metal cations are selected from the group consisting of sodium, potassium, calcium and magnesium.

9. The adsorbent-catalyst of claim 4 wherein the alkali and alkaline earth metal cations are selected from the group consisting of sodium, potassium, calcium and magnesium.

10. An adsorbent-catalyst for first catalyzing sulfur compounds conversion to higher molecular weight sulfur products and then adsorbing the resulting sulfur products from gas and liquid feed streams comprising a synthetic X or Y faujasite containing silica and alumina, wherein the silica to alumina molar ratio of the synthetic faujasite is from about 1.8:1 to about 5:1, wherein cations of the synthetic faujasite comprise from about 50 to about 75 percent transition metals and wherein the transition metals are selected from the group consisting of copper, zinc, cadmium and manganese.

11. The adsorbent-catalyst of claim 10 wherein the silica to alumina ratio is from about 2.0 to about 2.2.

12. The adsorbent-catalyst of claim 10 wherein the cations in the synthetic faujasite further comprise from about 25 to about 50 percent alkali or alkaline earth metals or combinations thereof.

13. The adsorbent-catalyst of claim 12 wherein the alkali and alkaline earth metal cations are selected from the group consisting of sodium, potassium, calcium and magnesium.

14. A process for purifying sulfur contaminated gas or liquid feed streams which comprises passing a sulfur compound contaminated gas or liquid feed stream over the adsorbent-catalyst of claim 1.

15. The process of claim 14 wherein the gas and liquid feed stream contains sulfur compounds in a range from about 1 ppm to about 500 ppm.

16. The process of claim 14 wherein the gas and liquid feed stream contains sulfur compounds in a range from about 10 ppm to about 300 ppm.

17. The process of claim 14 wherein the level of the sulfur compound contained in the gas and liquid feed stream after passage over the adsorbent-catalyst is from about 10 ppb to about 800 ppb.

18. The process of claim 14 further comprising maintaining the temperature of the gas or liquid feed stream at a temperature between about 10° C.-100° C.

19. The process of claim 14 wherein the sulfur contaminated gas stream is passed over the adsorbent-catalyst at a temperature from about 10 to about 60° C., pressures from atmospheric to about 120 bar and linear velocities from about 0.03 to about 0.4 m/sec.

20. The process of claim 14 wherein the sulfur contaminated liquid feed stream is passed over the adsorbent-catalyst at a temperature from about 10 to about 50° C. under pressures from about 3 to about 60 bar and liquid flow space velocities from about 0.1 to about 20 h⁻¹.

21. The process of claim 14 further comprising regenerating the adsorbent-catalyst by heating the adsorbent-catalyst to a temperature of about 180° to about 300° C.

22. A process for purifying sulfur contaminated gas or liquid feed streams which comprises passing a sulfur compound contaminated gas or liquid feed stream over the adsorbent-catalyst of claim 10.
